(19) United States
(12) Patent Application Publication
(10) Pub. No.: US 2024/0412475 A1
(43) Pub. Date: Dec. 12, 2024

(54) INFORMATION PROCESSING DEVICE TO CONTROL DISPLAY OF IMAGE, CONTROL METHOD FOR INFORMATION PROCESSING DEVICE, AND STORAGE MEDIUM

(71) Applicant: CANON KABUSHIKI KAISHA, Tokyo (JP)

(72) Inventor: HIROAKI KAMIJO, Saitama (JP)

(21) Appl. No.: 18/733,227

(22) Filed: Jun. 4, 2024

(30) Foreign Application Priority Data
Jun. 6, 2023 (JP) 2023-093384

(51) Int. Cl. G06T 19/20; G06F 3/14; G06T 7/70

(52) U.S. Cl. CPC G06T 19/20; G06F 3/14; G06T 7/70; G06T 2219/2004; G06T 2219/2016

(57) ABSTRACT

An information processing device connected to or integrated into a display device controls the display device to display a virtual object, obtains a first amount of change as an amount of change in one of a position and an orientation of a controller, obtains a second amount of change as an amount of change in one of a position and an orientation of the display device, estimates one of the position and the orientation of the display device based on a captured image, and obtains a third amount of change as an amount of change in one of the position and the orientation of the display device based on an estimation result, wherein the display device displays the virtual object based on a fourth amount of change as an amount of change in one of a position and an orientation based on the first, second and third amounts of change.

### BACKGROUND

### Field of the Disclosure

The present disclosure relates to a display device, an information processing device, a control method for a display device, and a storage medium.

### Description of the Related Art

In recent years, there have been known a mixed reality (MR) technique and a virtual reality (VR) technique each using a head-mounted display (HMD) to allow a user to feel a space different from a real space. In such technical fields, a technique for a user to perform various control operations on an HMD in a state where the user is wearing the HMD has been studied. The HMD performs control processing by obtaining information about a position and an orientation of the HMD from information obtained from an acceleration sensor and an angular velocity sensor that are included in the HMD.

In a case where the user rides in a vehicle, such as an automobile, wearing the HMD as described above, information obtained from the acceleration sensor and the angular velocity sensor can include not only information about a motion of the user, but also information about a motion of the vehicle. This may cause an issue that a video image captured in a direction different from a direction desired by the user can be displayed on a video display device. To address this issue, Japanese Patent Application Laid-Open No. 2019-049831 discusses a technique for determining a video image to be displayed on an HMD by subtracting vehicle motion information obtained from a motion sensor located on the vehicle from user motion information obtained from a motion sensor located on the user's body.

However, the related art discussed in Japanese Patent Application Laid-Open No. 2019-049831 may create a troublesome situation that, even in a case where the user uses the HMD without riding in a vehicle, an unnecessary motion sensor needs to be separately prepared and installed on a vehicle in addition to the motion sensor of HMD installed on the user's body.

### SUMMARY

Accordingly, the present disclosure is directed to providing a display device configured to perform operations by distinguishing a user operation from a motion of a moving body, without the need for separately preparing another motion sensor as described above even in a case where the user is riding in a moving body. According to an aspect of the present disclosure, an information processing device connected to or integrated into a display device configured to receive an input via a controller includes a display control unit configured to control the display device to display a virtual object, a first obtaining unit configured to obtain a first amount of change as an amount of change in one of a position and an orientation of the controller, a second obtaining unit configured to obtain a second amount of change as an amount of change in one of a position and an orientation of the display device, an image obtaining unit configured to obtain a captured image, an estimation unit configured to estimate one of the position and the orientation of the display device based on the captured image, and a third obtaining unit configured to obtain a third amount of change as an amount of change in one of the position and the orientation of the display device based on a result of the estimation by the estimation unit, wherein the display control unit controls the display device to display the virtual object based on a fourth amount of change that is an amount of change in one of a position and an orientation based on the first amount of change, the second amount of change, and the third amount of change.

Further features of the present disclosure will become apparent from the following description of exemplary embodiments with reference to the attached drawings.

### BRIEF DESCRIPTION OF THE DRAWINGS

FIG. 1 is a diagram illustrating an information processing system according to one or more aspects of the present disclosure.

FIG. 2 is a block diagram illustrating an example of a configuration of a head-mounted display (HMD) according to one or more aspects of the present disclosure.

FIG. 3 is a block diagram illustrating an example of a configuration of a controller according to one or more aspects of the present disclosure.

FIG. 4A is a diagram schematically illustrating an example of a scene in which the HMD is used in an automobile according to one or more aspects of the present disclosure.

FIG. 4B is a diagram schematically illustrating an example of a screen when the HMD is used in an automobile according to one or more aspects of the present disclosure.

FIG. 5 is a flowchart illustrating a processing procedure for the controller according to one or more aspects of the present disclosure.

FIG. 6 is a flowchart illustrating a processing procedure for the HMD according to one or more aspects of the present disclosure.

FIG. 7A is a diagram illustrating an example of a scenario in which no user operation is detected according to one or more aspects of the present disclosure.

FIG. 7B is a diagram illustrating an example of a screen when the HMD is used in an automobile in the scenario in which no user operation is detected according to one or more aspects of the present disclosure.

FIG. 8A is a diagram illustrating an example of a scenario in which a user operation is detected according to one or more aspects of the present disclosure.

FIG. 8B is a diagram illustrating an example of a screen when the HMD is used in the automobile in the scenario in which a user operation is detected according to one or more aspects of the present disclosure.

FIG. 9A illustrates an example of a scenario in which no user operation is detected according to one or more aspects of the present disclosure.

FIG. 9B is a diagram illustrating an example of a screen when the HMD is used in the automobile in the scenario in which no user operation is detected according to one or more aspects of the present disclosure.

FIG. 10A is a diagram illustrating an example of the scenario in which a user operation is detected according to the first exemplary embodiment.

FIG. 10B is a diagram illustrating an example of a screen when the HMD is used in the automobile in the scenario in which a user operation is detected according to one or more aspects of the present disclosure.

FIG. 11 is a flowchart illustrating a processing procedure for an HMD according to one or more aspects of the present disclosure.

FIG. 12A illustrates an example of a scenario in which a user operation is detected according to the second exemplary embodiment.

FIG. 12B is a diagram illustrating an example of a screen when the HMD is used in an automobile in the scenario in which a user operation is detected according to one or more aspects of the present disclosure.

### DESCRIPTION OF THE EMBODIMENTS

Exemplary embodiments of the present disclosure will be described in detail below with reference to the attached drawings. The following exemplary embodiments are not intended to limit the claimed disclosure. A plurality of features is described in the exemplary embodiments. However, not all of these features are essential to the disclosure, and these features may be arbitrarily combined. In the attached drawings, the same reference numerals are given to the same or similar components, and redundant description thereof is omitted.

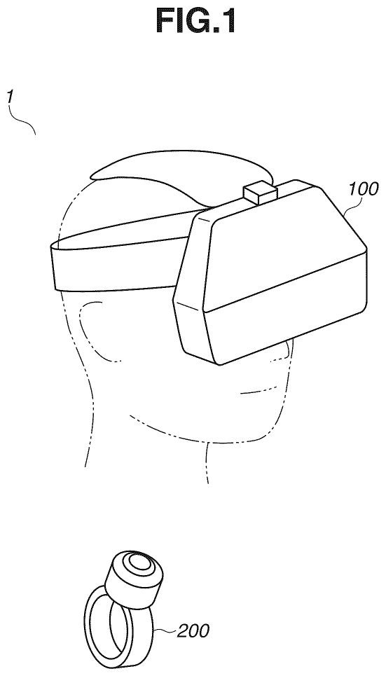

An information processing system 1 according to a first exemplary embodiment will be described with reference to FIG. 1. The information processing system 1 includes a head-mounted display (HMD) 100 and a controller 200.

The HMD 100 is a head-mounted type display device (electronic device) to be worn on a user's head. The HMD 100 displays a combined image obtained by combining a captured image that the HMD 100 obtains by image capturing of a range in front of a user with content such as computer graphics (CG) in a form according to an orientation of the HMD 100. The HMD 100 is connected to the controller 200 via Bluetooth®, and receives an input via the controller 200.

The controller 200 performs various control operations on the HMD 100. When a user operation is performed on the controller 200, the HMD 100 is controlled based on the user operation. As illustrated in FIG. 1, the controller 200 may have a finger ring shape (ring shape) that can be worn and supported on a user's finger, or may be a hand-held shape to be held by a user's hand. The controller 200 includes physical buttons to perform a determination operation and a selection operation on a display. The controller 200 performs wireless communication with the HMD 100 via Bluetooth®. While the present exemplary embodiment illustrates an example where the controller 200 has a finger-ring shaped controller or a hand-held controller, the shape of the controller 200 is not limited to these shapes, as long as the controller 200 can be supported by a user's finger, hand, or arm. While physical buttons are used in the present exemplary embodiment, any other member, such as a trackpad, a touch panel, a wheel, or a trackball, may be used as long as an operation can be performed with the member.

In the present exemplary embodiment, the information processing system 1 includes the HMD 100 and the controller 200. The components of the HMD 100 may be included in an information processing device such as a personal computer (PC), a smartphone, a game console, or a tablet terminal. In this case, the PC is connected to the HMD 100 via wired communication using a universal serial bus (USB®) cable or the like, or via wireless communication such as Bluetooth® or Wireless Fidelity (Wi-Fi®).

### <Internal Configuration of HMD>

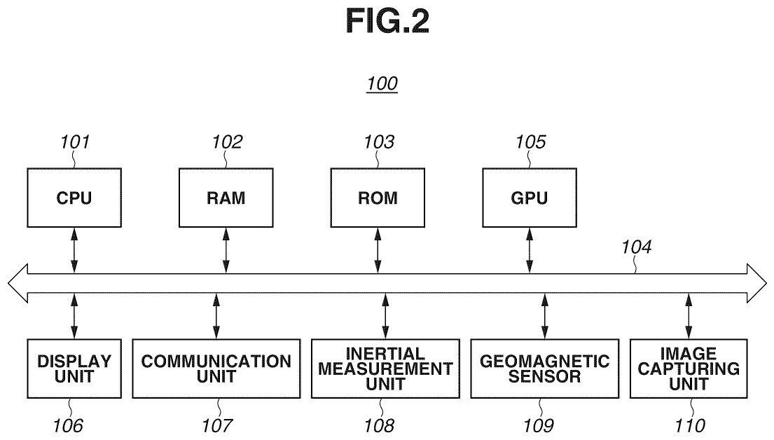

An internal configuration example of the HMD 100 will be described with reference to FIG. 2. The HMD 100 includes a central processing unit (CPU) 101, a random access memory (RAM) 102, a read-only memory (ROM) 103, a system bus 104, a graphics processing unit (GPU) 105, a display unit 106, a communication unit 107, an inertial measurement unit 108, a geomagnetic sensor 109, and an image capturing unit 110.

The CPU 101 executes programs stored in the ROM 103 using the RAM 102 as a working memory, and controls each component connected to the system bus 104. Instead of using the CPU 101 to control the entire device, processing may be shared among a plurality of pieces of hardware to control the entire device.

The RAM 102 is used as a buffer memory for temporarily holding image data captured by the image capturing unit 110, an image display memory for the display unit 106, a working area for the CPU 101, or the like.

The ROM 103 is an electrically erasable and recordable nonvolatile memory and stores programs and the like to be executed by the CPU 101 as described below. The programs stored in the ROM 103 include a program for implementing inertial information correction processing for the controller 200 to be described below.

The GPU 105 is a graphics processing device for drawing a virtual object on a virtual space. The CPU 101 controls display of an image to be displayed on the display unit 106 by the GPU 105.

The display unit 106 is an output device such as a liquid crystal panel or an organic electroluminescence (EL) panel to be used for display of drawn graphics. In a state where the user is wearing the HMD 100, organic EL panels are located in front of the user's eyes.

The communication unit 107 has a wired or wireless communication function, and communicates with a communication unit 205 of the controller 200 to transmit and receive data.

The inertial measurement unit 108 is a sensor for detecting a position and an orientation of the HMD 100. The inertial measurement unit 108 obtains positional information and orientation information about the user (i.e., the user wearing the HMD 100) corresponding to the position and the orientation of the HMD 100. The inertial measurement unit 108 includes an inertial measurement unit (IMU) including inertial sensors such as an acceleration sensor and an angular velocity sensor. The inertial measurement unit 108 is used to obtain positional information and orientation information about the user, and the CPU 101 obtains the positional information and the orientation information about the user from the inertial measurement unit 108. The inertial measurement unit 108 may be configured to detect only the orientation information, may be configured to detect only the positional information, or may be configured to detect both the orientation information and the positional information. In other words, the inertial measurement unit 108 may be configured to detect at least one of the orientation information and the positional information.

The geomagnetic sensor 109 is a sensor for detecting a direction of the HMD 100. The CPU 101 obtains information about the direction of the HMD 100 from the geomagnetic sensor 109. The geomagnetic sensor 109 may be included in the inertial measurement unit 108.

The image capturing unit 110 is a device for capturing an image of a surrounding environment of the HMD 100. The image capturing unit 110 includes to cameras (image capturing devices). The two cameras are located near right and left eyes of the user wearing the HMD 100 to capture a video image or an image of a space similar to the space viewed by the user in a normal state. Images of an object (a range in front of the user) captured by the two cameras are output to the CPU 101. The two cameras in the image capturing unit 110 can obtain information about a distance from the two cameras to the object as distance information through ranging by a stereo camera. The CPU 101 estimates the position of the HMD 100 by a known technique such as simultaneous localization and mapping (SLAM) based on the images obtained from the image capturing unit 110. An amount of change of the HMD 100 during a predetermined period is calculated based on the result of estimating the position and the orientation of the HMD 100. The image capturing unit 110 may capture a video image and output the captured video image. The CPU 101 may estimate the position of the HMD 100 not only by Visual SLAM for performing self-position estimation based on a video image obtained from the image capturing unit 110, but also by Light Detection and Ranging (LiDAR SLAM) using laser. The CPU 101 may be configured to perform self-position estimation by Depth SLAM using a Time-of-Flight (ToF) sensor.

### <Internal Configuration of Controller>

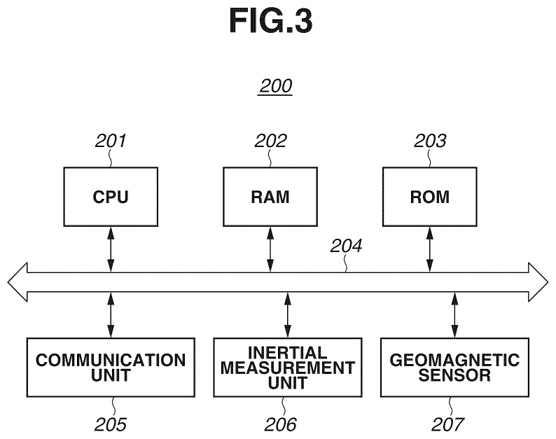

An example of an internal configuration of the controller 200 will be described with reference to FIG. 3.

The controller 200 includes a CPU 201, a RAM 202, a ROM 203, a system bus 204, the communication unit 205, an inertial measurement unit 206, and a geomagnetic sensor 207.

The CPU 201 executes programs stored in the ROM 203 using the RAM 202 as a working memory, thereby controlling each component connected to the system bus 204. Instead of the configuration in which the CPU 201 controls the entire device, processing may be shared among a plurality of pieces of hardware to control the entire device. Instead of the configuration in which the CPU 201 controls the controller 200, the CPU 101 may perform processing to be performed by the CPU 201.

The RAM 202 is used as a buffer memory for temporarily holding data on a position and an orientation detected by the inertial measurement unit 206, a working area for the CPU 201, or the like.

The ROM 203 is an electrically erasable and recordable nonvolatile memory, and stores programs and the like to be executed by the CPU 201. The programs stored in the ROM 203 include a program for implementing processing of transmitting information about the orientation, motion, and direction of the controller 200 to be described below to the HMD 100.

The communication unit 205 has a wired or wireless communication function, and communicates with the communication unit 107 of the HMD 100 to transmit and receive data.

The inertial measurement unit 206 is a sensor for detecting a position and an orientation of the controller 200. The inertial measurement unit 206 obtains positional information and orientation information about a hand or a finger of the user (i.e., the user wearing the controller 200) corresponding to the position and the orientation of the controller 200. The inertial measurement unit 206 includes an inertial measurement unit including inertial sensors such as an acceleration sensor and an angular velocity sensor. The inertial measurement unit 206 is used to obtain positional information and orientation information about the user, and the CPU 201 obtains the positional information and the orientation information about the user from the inertial measurement unit 206. The inertial measurement unit 206 may be configured to detect only the orientation information, may be configured to detect only the positional information, or may be configured to detect both the orientation information and the positional information. In other words, the inertial measurement unit 206 may be configured to detect at least one of the orientation information and the positional information. The positional information and the orientation information about the user to be detected by the inertial measurement unit 206 may be obtained by the CPU 101.

The geomagnetic sensor 207 is a sensor for detecting a direction of the controller 200. The CPU 201 obtains information about the direction of the controller 200 from the geomagnetic sensor 207.

### <Example of Operation in Related Art>

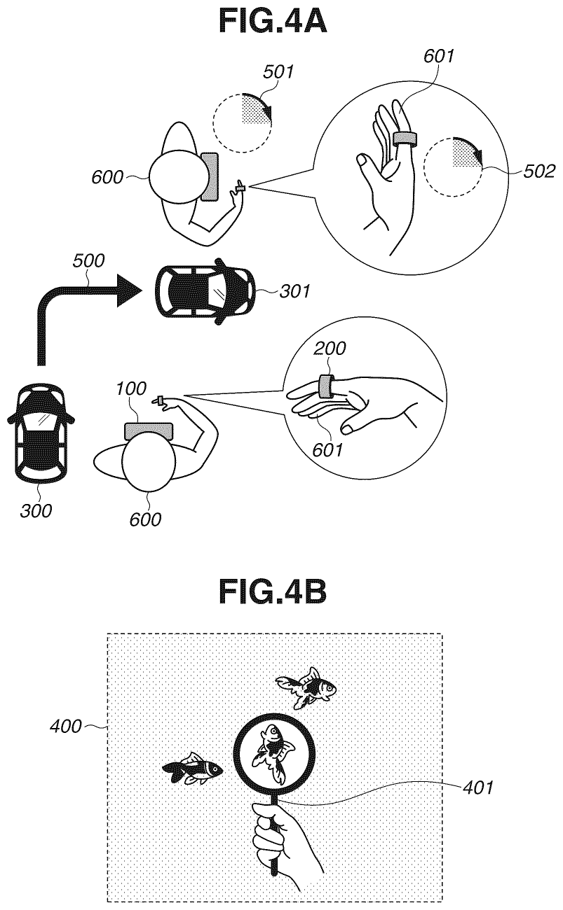

An example of a scene in which the user, which is an example of a moving body, uses the HMD 100 while riding in an automobile will be described with reference to FIGS. 4A and 4B. An outline of processing in the related art based on inertial information about the HMD 100 and the controller 200 will be described.

FIG. 4A illustrates an example of a scene in which a user 600 is wearing the HMD 100 on the head and is also wearing the controller 200 on a user's finger 601 while riding in an automobile 300, which is an example of the moving body.

Assume a case where the automobile 300 has moved along a movement trajectory 500, and during this movement, the user does not perform any user operation in a state where the HMD 100 and the controller 200 are held stationary in the automobile 300. In this case, orientation information obtained by the angular velocity sensor is described, and the description of positional information obtained by the acceleration sensor is omitted. For ease of explanation, the amount of change is represented by a rotation angle about an axis along a gravity direction. At a point of an automobile 301, a change in the orientation of the HMD 100 worn on the head of the user 600 as indicated by inertial information 501 is detected by the inertial measurement unit 108. A change in the orientation of the controller 200 worn on the user's finger 601 as indicated by inertial information 502 is detected by the inertial measurement unit 206. That is, the inertial measurement unit 108 in the HMD 100 and the inertial measurement unit 206 in the controller 200 detect the amount of change in the orientation from the automobile 300 to the automobile 301.

FIG. 4B is a diagram illustrating an example of a screen for a virtual space 400 displayed on the display unit 106 of the HMD 100 at the point of the automobile 300. The screen for the virtual space 400 to be displayed on the display unit 106 is changed according to the position and the orientation of the HMD 100. In this case, assume a scene in which the user plays a goldfish scooping game in a state where the user is riding in an automobile. A scoop 401 that is a tool used for scooping goldfish is displayed as a virtual object in the virtual space 400 based on the position and orientation of the controller 200. Assume that the user plays a goldfish scooping game in a state where an avatar of the user is sitting in the virtual space. The position of the avatar is fixed and the user can change the direction in which the user views a water tank in which goldfish is swimming by moving the neck by 360°. In this goldfish scooping game, when the user moves his/her head, the screen to be displayed on the display unit 106 is changed according to the position and the orientation of the user's head, i.e., the position and orientation of the HMD 100. For ease of explanation, assume a case where the screen is changed according to a change in the orientation. In this case, a change in the position of the automobile based on a movement of the automobile is not taken into consideration, and a change in the orientation of the user based on a movement of the automobile, i.e., a change in the direction of the user based on a movement of the automobile, is taken into consideration.

As illustrated in FIG. 4A, assume that the automobile 300 turns right by 90° and moves to the point of the automobile 301 and the user does not move during the movement. If the user is not riding in the automobile 300 and the user does not move, a display screen is not changed. In this case, however, the screen displayed on the display unit 106 of the HMD 100 is changed in the same manner as when the user's head turns right by 90° based on the inertial information 501 detected by the inertial measurement unit 108. The scoop 401 in the virtual space 400 drawn by the HMD 100 also moves rightward by 90° based on the inertial information 501 about the controller 200 detected by the inertial measurement unit 206. In other words, a background video image on the display screen is changed, while the position of the scoop 401 on the display screen is not changed. In this case, although the user is sitting still in the automobile, inertial information is detected due to a movement of the automobile and it is recognized that the user has moved, so that the screen and the virtual object are changed accordingly.

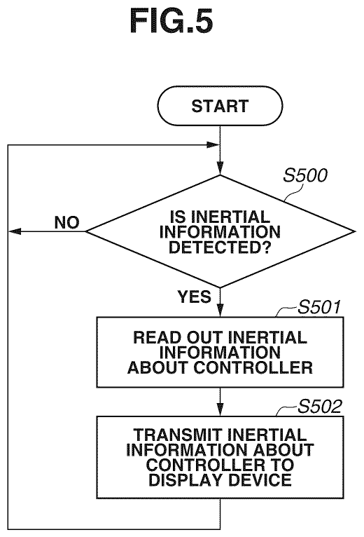

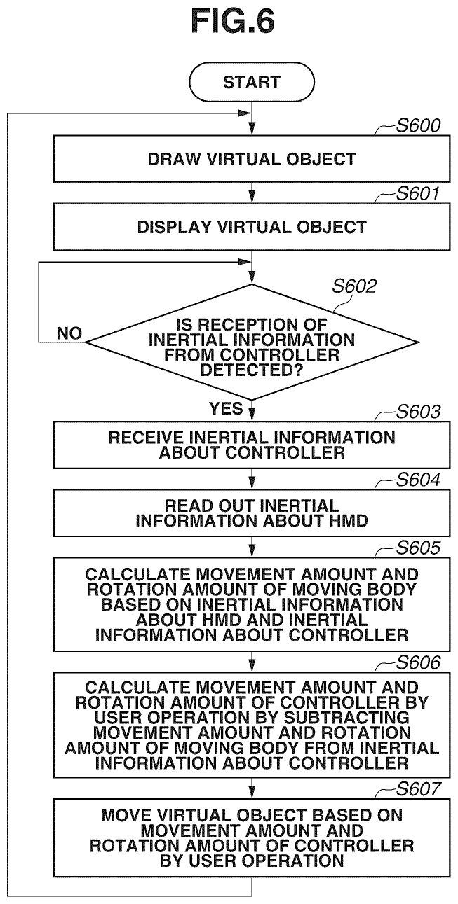

A flow of processing illustrative of processing performed by CPU 101 according to the present exemplary embodiment will be described below with reference to FIGS. 5 and 6.

### <Processing Performed by Controller Upon Detection of User Operation>

Processing to be performed by the controller 200 when a user operation is detected will be described with reference to a flowchart illustrated in FIG. 5. In step S500, the CPU 201 determines whether inertial information about the controller 200 is detected by the inertial measurement unit 206, or whether a change in the position and orientation of the controller 200 is detected. If the CPU 201 determines that inertial information about the controller 200 is detected (YES in step S500), the processing proceeds to step S501. If the CPU 201 determines that inertial information about the controller 200 is not detected (NO in step S500), the processing of step S500 is repeatedly performed.

In step S501, the CPU 201 reads out inertial information about the controller 200 from the inertial measurement unit 206.

In step S502, the CPU 201 transmits the inertial information about the controller 200 to the CPU 101 of the HMD 100 via the communication unit 205. The processing in the flowchart illustrated in FIG. 5 is performed by the CPU 201, but instead may be performed by the CPU 101 of the HMD 100.

### <Processing Performed by HMD Upon Receipt of Data>

Processing in which the HMD 100 receives inertial information from the controller 200 and moves a virtual object will be described with reference to a flowchart illustrated in FIG. 6.

In step S600, the CPU 101 controls the GPU 105 to draw a virtual object on which a user operation is to be performed, and then the processing proceeds to step S601.

In step S601, the CPU 101 controls the display unit 106 to display the virtual object on which the user operation is to be performed, and then the processing proceeds to step S602.

In step S602, the CPU 101 determines whether reception of inertial information from the controller 200 is detected. If the CPU 101 determines that reception of inertial information from the controller 200 is detected (YES in step S602), the processing proceeds to step S603. If the CPU 101 determines that reception of inertial information from the controller 200 is not detected (NO in step S602), the processing of step S602 is repeatedly performed.

In step S603, the CPU 101 receives inertial information about the controller 200 via the communication unit 107, and then the processing proceeds to step S604.

In step S604, the CPU 101 reads out inertial information about the HMD 100 from the inertial measurement unit 108, and then the processing proceeds to step S605.

In step S605, the CPU 101 calculates a movement amount and a rotation amount of the moving body based on the read inertial information about the HMD 100 and the received inertial information about the controller 200. In a case where the user uses the HMD 100 while riding in the moving body, an instruction to prompt the user not to shake his/her head to a large extent may be issued so that inertial information about the HMD 100 can be regarded as inertial information about the moving body. The amount of change in components of the inertial information about the HMD 100 that match the components of the inertial information about the controller 200 may be used as the movement amount and the rotation amount of the moving body.

In step S606, the CPU 101 calculates a movement amount and a rotation amount of the controller 200 that are caused by a user operation by subtracting the movement amount and the rotation amount of the moving body from the inertial information about the controller 200, and then the processing proceeds to step S607. The movement amount and the rotation amount of the controller 200 that are caused by a user operation correspond to the movement amount and the rotation amount of the controller 200 relative to the HMD 100.

In step S607, the CPU 101 moves coordinates of the virtual object based on the movement amount and the rotation amount of the controller 200 that are caused by a user operation, and then the processing returns to step S600.

A method for calculating the movement amount and the rotation amount of the moving body and a method for calculating the movement amount and the rotation amount of the controller 200 will be described below.

In the flowchart illustrated in FIG. 6, after the processing of step S604, the processing may proceed to step S606 and the CPU 101 may calculate the movement amount and the rotation amount of the controller 200 that are caused by a user operation by subtracting the inertial information about the HMD 100 from the inertial information about the controller 200, and then the processing may proceed to step S607.

### <Method for Calculating Rotation Amount of Moving Body and Method for Calculating Rotation Amount of Controller Caused by User Operation>

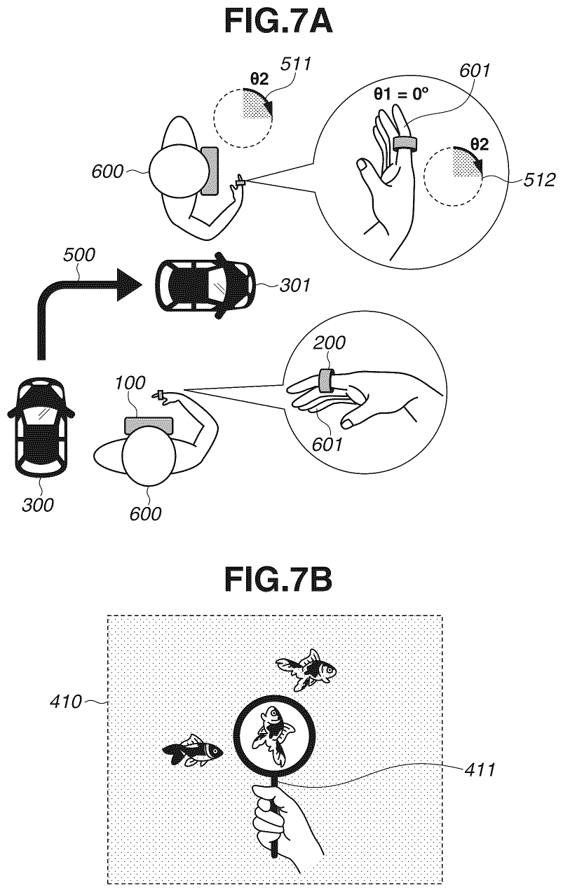

An example where the rotation amount of the moving body is identified based on angular velocities obtained from inertial information about the HMD 100 and inertial information about the controller 200, only an amount of operation added by a user operation is extracted, and the extracted amount of operation is reflected as the user operation will be described with reference to FIGS. 4B, 7A, and 7B. Assume herein that the user does not move during a movement of the moving body. In this case, orientation information obtained by the angular velocity sensor is described, and the description of positional information obtained by the acceleration sensor is omitted. For ease of explanation, the amount of change is represented by a rotation angle about the Z-axis.

FIG. 7A is a diagram illustrating an example of a scene in which the user 600 riding in the automobile 300 is wearing the HMD 100 on the head and is also wearing the controller 200 on the user's finger 601. Assume a case where the automobile 300 has moved along the movement trajectory 500. During this movement, the user does not perform any user operation in a state where the HMD 100 and the controller 200 are held stationary in the automobile. At the point of the automobile 301, a change (θ2) in the orientation of the HMD 100 worn on the head of the user 600 as indicated by inertial information 511 is detected by the inertial measurement unit 108.

The change (θ2) in the orientation of the controller 200 worn on the user's finger 601 as indicated by inertial information 512 is detected by the inertial measurement unit 206. That is, the inertial measurement unit 108 in the HMD 100 and the inertial measurement unit 206 in the controller 200 detect the amount of change (θ2) in the orientation from the automobile 300 to the automobile 301, i.e., the amount of change (θ2) in the direction of the automobile. The CPU 101 of the HMD 100 calculates a rotation amount (θ1) of the controller 200 that is caused by a user operation by subtracting the inertial information 511 about the HMD 100 from the inertial information 512 about the controller 200. In the example illustrated in FIG. 7A, no user operation has been performed, and thus the rotation amount (θ1) of the controller 200 that is caused by a user operation is 0°.

FIG. 7B is a diagram illustrating an example of a screen for a virtual space 410 displayed on the display unit 106 of the HMD 100 at the point of the automobile 301. A scoop 411 that is a tool used for scooping goldfish is displayed as a virtual object in the virtual space 410 based on the position and orientation of the controller 200. Since no user operation has been performed, the rotation amount (θ1) of the controller 200 that is caused by a user operation is calculated as 0°. Accordingly, the display screen is not changed from the display screen illustrated in FIG. 4B.

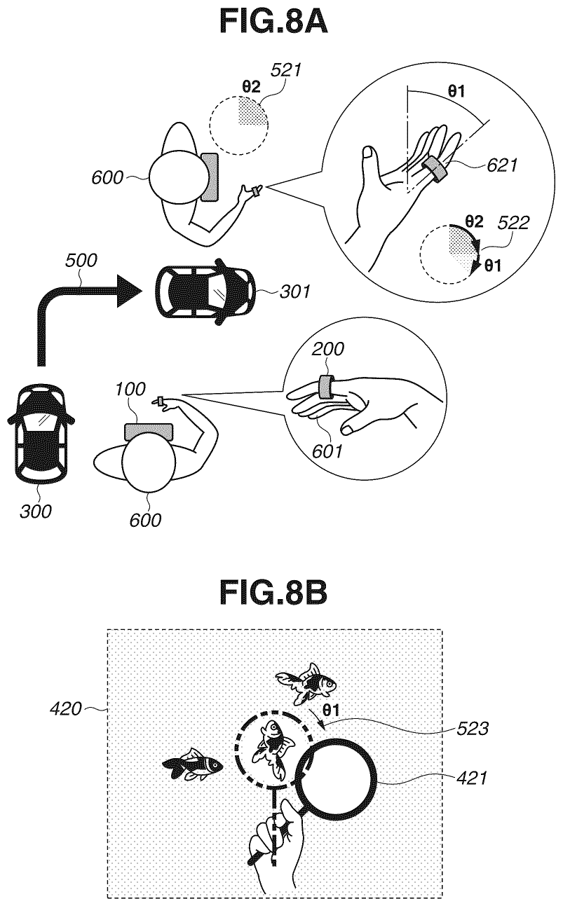

An example where the rotation amount of the moving body is identified based on angular velocities obtained from inertial information about the HMD 100 and inertial information about the controller 200, only an amount of operation added by a user operation is extracted, and the extracted amount of operation is reflected as the user operation will be described with reference to FIGS. 4B, 8A, and 8B. Assume herein that, during a movement of the moving body, the user has not moved the HMD 100 and has moved only the controller 200. In this case, only orientation information obtained by the angular velocity sensor is described, and the description of positional information obtained by the acceleration sensor is omitted. For ease of explanation, the amount of change is represented by a rotation angle about the Z-axis.

FIG. 8A is a diagram illustrating an example of a scene in which the user 600 riding in the automobile 300 is wearing the HMD 100 on the head and is also wearing the controller 200 on the user's finger 601. Assume a case where the automobile 300 has moved along the movement trajectory 500. Assume that, during this movement, the user does not move the HMD 100 and moves only the controller 200 in the automobile. Assume that the finger 601 with the controller 200 is moved to the position of the finger 621. The orientation of the controller 200 is changed by the rotation amount (θ1) by a user operation.

At the point of the automobile 301, the change (θ2) in the orientation of the HMD 100 worn on the head of the user 600 as indicated by inertial information 521 is detected by the inertial measurement unit 108. A change (θ1+θ2) in the orientation of the controller 200 worn on the user's finger 601 as indicated by inertial information 522 is detected by the inertial measurement unit 206. That is, the inertial measurement unit 108 in the HMD 100 and the inertial measurement unit 206 in the controller 200 detect the amount of change (θ2) in the orientation from the automobile 300 to the automobile 301, or the amount of change (θ2) in the direction of the automobile. The CPU 101 of the HMD 100 calculates the rotation amount (θ1) of the controller 200 caused by a user operation by subtracting inertial information 521 (θ2) about the HMD 100 from inertial information 522 (θ1+θ2) about the controller 200.

FIG. 8B is a diagram illustrating an example of a screen for a virtual space 420 displayed on the display unit 106 of the HMD 100 at the point of the automobile 301. Since a user operation has been performed, the display screen is changed from the display screen illustrated in FIG. 4B based on the rotation amount (θ1) of the controller 200 that is caused by a user operation, and a scoop 421 is displayed on the display unit 106 of the HMD 100 in a state where the scoop 421 is rotated by a rotation amount 523 (θ1) of the controller 200.

Specific numerical values are applied, and assume that the direction of the automobile is changed by an amount of change (θ2=90°) and the user has moved the controller 200 by a rotation amount (θ1=45°). In this case, the inertial measurement unit 108 in the HMD 100 detects (θ2=90°), and the inertial measurement unit 206 in the controller 200 detects (θ1+θ2=135°). The CPU 101 of the HMD 100 performs control processing to calculate (θ1=45°) by subtracting the rotation amount of the controller 200. According to the exemplary embodiment described above, it is possible to provide the HMD 100 configured to accurately detect a user operation based on operation information about the controller 200 and operation information about the HMD 100 even in a case where the user is riding in a moving body.

In the present exemplary embodiment, the rotation amount is calculated based on inertial information obtained by the inertial measurement unit 108 and inertial information obtained by the inertial measurement unit 206, but instead may be calculated based on geomagnetic information obtained by the geomagnetic sensor 109 and geomagnetic information obtained by the geomagnetic sensor 207.

### <Method for Calculating Movement Amount of Moving Body and Method for Calculating Movement Amount of Controller Caused by User Operation>

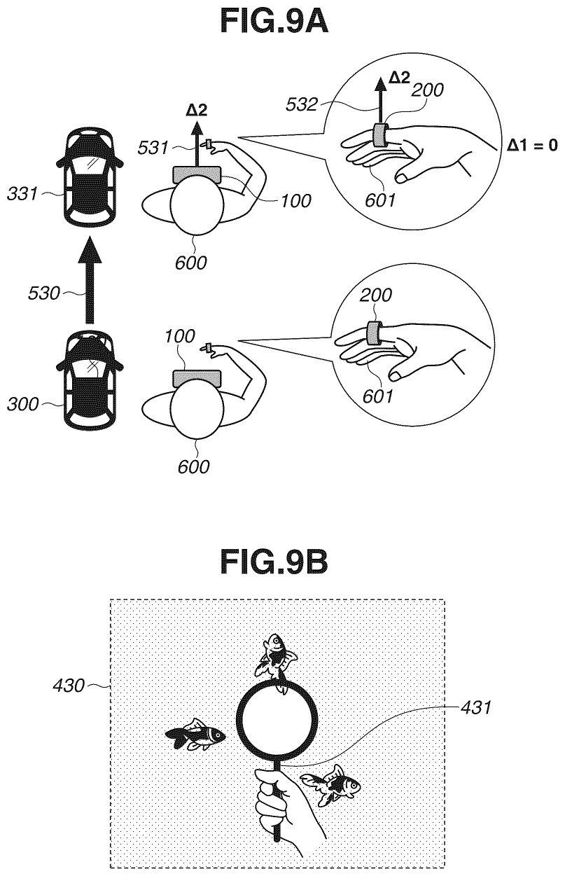

An example where the movement amount of the moving body is identified based on accelerations obtained from inertial information about the HMD 100 and inertial information about the controller 200, only an amount of operation added by a user operation is extracted, and the extracted amount of operation is reflected as the user operation will be described with reference to FIGS. 9A and 9B. Assume a case where the user does not move during a movement of the moving body. In this case, orientation information obtained by the acceleration sensor is described, and the description of orientation information obtained by the angular velocity sensor is omitted. In this case, the amount of change in the position in a forward direction is described for ease of explanation.

FIG. 9A is a diagram illustrating an example of a scene in which the user 600 riding in the automobile 300 is wearing the HMD 100 on the head and is also wearing the controller 200 on the user's finger 601. Assume a case where the automobile 300 has moved along a movement trajectory 530. During this movement, the user does not perform any user operation in a state where the HMD 100 and the controller 200 are held stationary in the automobile. At a point of an automobile 331, a change (Δ2) in the position of the HMD 100 worn on the head of the user 600 as indicated by inertial information 531 is detected by the inertial measurement unit 108. The change (Δ2) in the position of the controller 200 worn on the user's finger 601 as indicated by inertial information 532 is detected by the inertial measurement unit 206. That is, the inertial measurement unit 108 in the HMD 100 and the inertial measurement unit 206 in the controller 200 detect the amount of change (Δ2) in the position from the automobile 300 to the automobile 331. The CPU 101 of the HMD 100 calculates the movement amount (Δ1) of the controller 200 caused by a user operation, i.e., the amount of change (Δ1) in the position, by subtracting the inertial information 511 about the HMD 100 from the inertial information 512 about the controller 200. In the example illustrated in FIG. 7A, no user operation has been performed, and thus the movement amount (Δ1) of the controller 200 caused by a user operation is “0”.

FIG. 9B is a diagram illustrating an example of a screen for a virtual space 430 displayed on the display unit 106 of the HMD 100 at the point of the automobile 300. The screen for the virtual space 430 to be displayed is changed according to the position and the orientation of the HMD 100. Assume a case where the user plays a goldfish scooping game while riding in an automobile. A scoop 431 is displayed as a virtual object in the virtual space 430 based on the position and the orientation of the controller 200. Also, in the case where the moving body has moved along the movement trajectory 530, the CPU 101 of the HMD 100 calculates the movement amount (Δ1) of the controller 200 caused by a user operation as “0”, and thus the same screen is displayed.

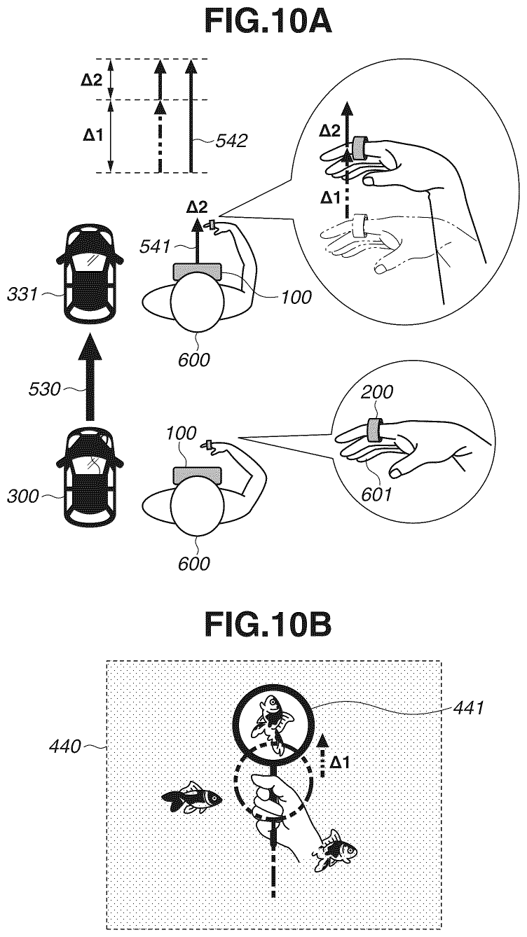

An example where the movement amount of the moving body is identified based on accelerations obtained from inertial information about the HMD 100 and inertial information about the controller 200, only an amount of operation added by a user operation is extracted, and the extracted amount of operation is reflected as the user operation will be described with reference to FIGS. 9B, 10A, and 10B. Assume herein that, during a movement of the moving body, the user has not moved the HMD 100 and has moved only the controller 200. In this case, orientation information obtained by the acceleration sensor is described, and the description of orientation information obtained by the angular velocity sensor is omitted. In this case, the amount of change in the position in the X-axis direction is described for ease of explanation.

FIG. 10A is a diagram illustrating an example of a scene in which the user 600 riding in the automobile 300 is wearing the HMD 100 on the head and is also wearing the controller 200 on the user's finger 601. Assume a case where the automobile 300 has moved along the movement trajectory 530. Assume that, during this movement, the user does not move the HMD 100 and moves only the controller 200 in the automobile. The position of the controller 200 is changed by the amount (Δ1) by a user operation. At the point of the automobile 331, the change (Δ2) in the position of the HMD 100 worn on the head of the user 600 as indicated by inertial information 541 is detected by the inertial measurement unit 108. A change (Δ1+Δ2) in the position of the controller 200 worn on the user's finger 601 as indicated by inertial information 542 is detected by the inertial measurement unit 206. That is, the inertial measurement unit 108 in the HMD 100 and the inertial measurement unit 206 in the controller 200 detect the amount of change (Δ2) in the position from the automobile 300 to the automobile 331, i.e., the amount of change (Δ2) in the movement of the automobile. The CPU 101 of the HMD 100 calculates the movement amount (Δ1) of the controller 200 that is caused by a user operation by subtracting the inertial information 541 (Δ2) about the HMD 100 from the inertial information 542 (Δ1+Δ2) about the controller 200.

FIG. 10B is a diagram illustrating an example of a screen for a virtual space 440 displayed on the display unit 106 of the HMD 100 at the point of the automobile 331. Since a user operation has been performed, the display screen is changed from the display screen illustrated in FIG. 9B based on the movement amount (Δ1) of the controller 200 caused by the user operation, and a scoop 441 is displayed on the display unit 106 of the HMD 100 in a state where the scoop 441 is moved by the movement amount (Δ1) of the controller 200. According to the exemplary embodiment described above, it is possible to provide the HMD 100 configured to detect a user movement operation from inertial information about the controller 200 and inertial information about the HMD 100 even in a case where the user is riding in a moving body.

A difference between accelerations detected by the inertial measurement unit 108 or the inertial measurement unit 206 may be obtained, and the movement amount may be calculated by integrating the acceleration corresponding to the difference twice.

While the first exemplary embodiment described above illustrates an example where the HMD 100 is worn on the user's head as a display device, the display device may include a display that is placed or fixed on a moving body. In this case, it may be regarded that inertial information obtained by the display device matches inertial information about the moving body, and the movement amount and the rotation amount of the controller 200 caused by a user operation may be calculated by subtracting inertial information obtained by the display device from inertial information obtained by the controller 200.

In other words, the movement amount and the rotation amount of the controller 200 relative to the moving body may be calculated.

In a second exemplary embodiment, the CPU 101 of the HMD 100 estimates the position of the HMD 100 in a moving body based on an image captured by the image capturing unit 110 by using a technique such as SLAM. In the second exemplary embodiment, the CPU 101 of the HMD 100 can calculate the amount of change in the position and orientation changed in the moving body during a predetermined period as a result of estimating the position of the HMD 100 in the moving body.

The CPU 101 of the HMD 100 draws a background image in a virtual space using the result of estimating the position and orientation of the HMD 100.

### <Processing Performed by HMD Upon Receipt of Data>

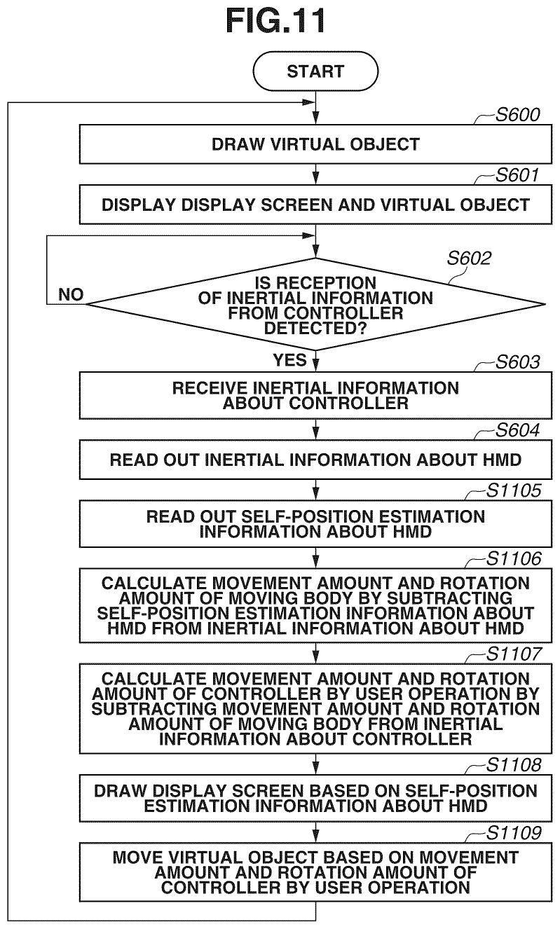

Processing in which the HMD 100 receives inertial information from the controller 200 and moves a virtual object will be described with reference to a flowchart illustrated in FIG. 11.

In step S600, the CPU 101 controls the GPU 105 to draw a virtual object on which a user operation is to be performed, and then the processing proceeds to step S601.

In step S601, the CPU 101 controls the display unit 106 to display a display screen and the virtual object on which a user operation is to be performed, and then the processing proceeds to step S602.

In step S602, the CPU 101 determines whether reception of inertial information from the controller 200 is detected. If the CPU 101 determines that reception of inertial information from the controller 200 is detected (YES in step S602), the processing proceeds to step S603. If the CPU 101 determines that reception of inertial information from the controller 200 is not detected (NO in step S602), the processing of step S602 is repeatedly performed.

In step S603, the CPU 101 receives inertial information about the controller 200 via the communication unit 107, and then the processing proceeds to step S604.

In step S604, the CPU 101 reads out inertial information about the HMD 100 from the inertial measurement unit 108, and then the processing proceeds to step S1105.

In step S1105, the CPU 101 estimates the position of the HMD 100 in the moving body based on a captured image obtained by the image capturing unit 110. The movement amount and the rotation amount of the HMD 100 in the moving body are calculated as self-position estimation information about the HMD 100, and then the processing proceeds to step S1106.

In step S1106, the CPU 101 calculates the movement amount and the rotation amount of the moving body by subtracting the self-position estimation information about the HMD 100 in the moving body from the inertial information about the HMD 100, and then the processing proceeds to step S1107.

In step S1107, the CPU 101 calculates the movement amount and the rotation amount of the controller 200 caused by a user operation by subtracting the movement amount and the rotation amount of the moving body from the inertial information about the controller 200, and then the processing proceeds to step S1108. In this case, the movement amount and the rotation amount of the controller 200 caused by a user operation correspond to the movement amount and the rotation amount of the controller 200 relative to the moving body.

In step S1108, the CPU 101 controls the GPU 105 to draw a display screen, i.e., a background image, to be displayed on the display unit 106 based on the self-position estimation information about the HMD 100 in the moving body, and then the processing proceeds to step S1109.

In step S1109, the CPU 101 moves coordinates of the virtual object based on the movement amount and the rotation amount of the controller 200 caused by a user operation, and then the processing returns to step S600.

A method for calculating the movement amount and the rotation amount of the moving body and a method for calculating the movement amount and the rotation amount of the controller 200 caused by a user operation will be described below.

<Method for Calculating Rotation Amount of Moving Body and Method for Calculating Rotation Amount of controller Caused by User Operation>

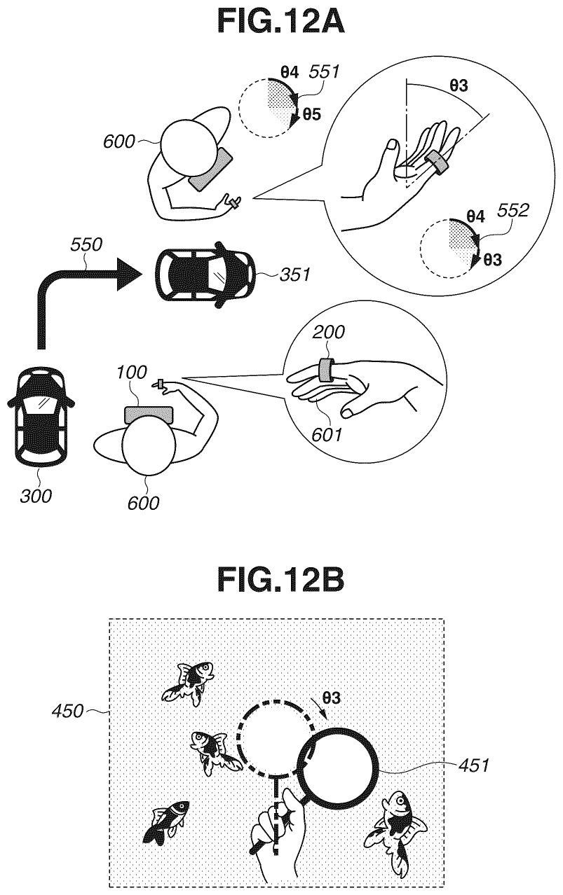

An example where the rotation amount of the moving body is identified based on angular velocities of the HMD 100 and the controller 200 and the self-position estimation information about the HMD 100 in the moving body, only a rotation amount added by a user operation is extracted, and the extracted rotation amount is reflected will be described with reference to FIGS. 4B, 12A, and 12B.

Assume a case where, during a movement of the moving body, the user has moved both the HMD 100 and the controller 200. In this case, orientation information obtained by the angular velocity sensor is described, and the description of positional information obtained by the acceleration sensor is omitted. For ease of explanation, the amount of change is represented by a rotation angle about the Z-axis.

FIG. 12A is a diagram illustrating an example of a scene in which the user 600 riding in the automobile 300 is wearing the HMD 100 on the head and is also wearing the controller 200 on the user's finger 601. Assume a case where the automobile 300 has moved along a movement trajectory 550. Assume that, during this movement, the user has moved both the HMD 100 and the controller 200 in the automobile.

The orientation of the controller 200 is changed by an amount (θ3) by a user operation. At a point of an automobile 351, the orientation is changed by an amount of change (θ4). At this point, the CPU 101 calculates a change (θ5) in the orientation of the HMD 100 worn on the head of the user 600 as self-position estimation information. A change (θ4+θ5) in the orientation of the HMD 100 worn on the head of the user 600 as indicated by inertial information 551 is detected by the inertial measurement unit 108. A change (θ3+θ4) in the orientation of the controller 200 worn on the user's finger 601 as indicated by inertial information 552 is detected by the inertial measurement unit 206.

The CPU 101 of the HMD 100 calculates the rotation amount (θ4) of the moving body by subtracting the change (θ5) in the orientation based on the self-position estimation information about the HMD 100 in the moving body from the inertial information 551 (θ4+θ5) about the HMD 100. The CPU 101 of the HMD 100 calculates the rotation amount (θ3) caused by a user operation by subtracting the rotation amount (θ4) of the moving body from the inertial information 552 (θ3+θ4) about the controller 200. Assume herein that the rotation amount (θ3) caused by a user operation is calculated after the rotation amount (θ4) of the moving body is calculated once. However, the rotation amount (θ3) caused by a user operation may be calculated at once by subtracting the inertial information 551 (θ4+θ5) from a sum of the change (θ5) in the orientation based on the self-position estimation information about the HMD 100 in the moving body and the inertial information 552 (θ3+θ4).

FIG. 12B is a diagram illustrating an example of a screen for a virtual space 450 displayed on the display unit 106 of the HMD 100 at the point of the automobile 351. Since a user operation has been performed, the display screen is changed from the display screen illustrated in FIG. 4B based on the rotation amount (θ3) of the controller 200 caused by the user operation, and a scoop 451 is displayed on the display unit 106 of the HMD 100 in a state where the scoop 451 is rotated by the rotation amount (θ3) of the controller 200. A background video image is displayed on the display unit 106 of the HMD 100 in a state where the background video image is rotated by the amount of change (θ5) in the orientation based on the self-position estimation information about the HMD 100 in the moving body.

Specific numerical values are applied, and assume that the orientation of the automobile is changed by an amount of change (θ4=90°) and the user has moved the controller 200 by a rotation amount (θ3=45°). Also, assume that the user has moved the HMD 100 by an amount of change (θ5=45°) in the moving body. In this case, the inertial measurement unit 108 in the HMD 100 detects (θ4+θ5=135°), and the inertial measurement unit 206 in the controller 200 detects (θ3+θ4=135°). The CPU 101 of the HMD 100 calculates the rotation amount (θ4=45°) of the moving body by subtracting the amount of change (θ5=45°) in the orientation based on the self-position estimation information about the HMD 100 in the moving body from the inertial information 551 (θ4+θ5=135°) about the HMD 100. The CPU 101 of the HMD 100 calculates the rotation amount (θ3=45°) caused by a user operation by subtracting the rotation amount (θ4=45°) of the moving body from the inertial information 552 (θ3+θ4=135°) about the controller 200. According to the exemplary embodiment described above, it is possible to provide the HMD 100 configured to accurately detect a user operation based on self-position estimation information about the HMD 100, inertial information about the controller 200, and inertial information about the HMD 100 even in a case where the user is riding in a moving body.

### OTHER EXEMPLARY EMBODIMENTS

The present disclosure can be implemented by executing the following processing. That is, software (program) for implementing functions according to the exemplary embodiments described above is supplied to a system or a device via a network or various storage media, and a computer (or a control unit, a micro processing unit (MPU), etc.) of the system or the device reads out and executes a program code. In this case, the program and storage media storing the program are included in the present disclosure.

The present disclosure has been described in detail above based on some exemplary embodiments. However, the present disclosure is not limited to these specific exemplary embodiments, and various modes within the gist of the disclosure are also included in the present disclosure. Some of the exemplary embodiments may be combined as appropriate.

Each functional unit in the exemplary embodiments (modified examples) described above may be or may not be an individual piece of hardware. Functions of two or more functional units may be implemented by common hardware. Each of functions of a single functional unit may be implemented by an individual piece of hardware. Two or more functions of a single functional unit may be implemented by common hardware. Alternatively, each functional unit may be or may not be implemented by hardware such as an application-specific integrated circuit (ASIC), a field-programmable gate array (FPGA), or a digital signal processor (DSP). For example, the device may include a processor and a memory (storage medium) storing control programs. Functions of at least some of functional units included in the device may be implemented by the processor reading out the control programs from the memory and executing the control programs.

### [Configuration 1]

A display device configured to receive an input via a controller, the display device including a display control unit configured to display a virtual object on the display device, an obtaining unit configured to obtain a first amount of change as an amount of change in at least one of a position and an orientation of the controller, an inertial sensor configured to detect a second amount of change as an amount of change in at least one of a position and an orientation of the display device, in which the display control unit displays the virtual object on the display device based on a third amount of change, the third amount of change being an amount of change in at least one of a position and an orientation based on the first amount of change and the second amount of change.

### [Configuration 2]

The display device according to configuration 1, in which the third amount of change is an amount of change of the controller relative to the display device.

### [Configuration 3]

The display device according to configuration 1 or 2, in which the third amount of change is an amount of change obtained by subtracting the second amount of change from the first amount of change.

### [Configuration 4]

The display device according to any one of configurations 1 to 3, in which the display device is fixed to a moving body in which a user is riding.

### [Configuration 5]

The display device according to configuration 1, further including an image capturing unit configured to obtain a captured image, an estimation unit configured to estimate at least one of the position and the orientation of the display device based on the captured image, and a fourth obtaining unit configured to obtain a fourth amount of change as an amount of change in at least one of the position and the orientation of the display device, based on a result of estimation by the estimation unit, in which the display control unit displays the virtual object on the display device based on the third amount of change that is based on the first amount of change, the second amount of change, and the fourth amount of change.

### [Configuration 6]

The display device according to configuration 5, in which the third amount of change is an amount of change obtained by subtracting the second amount of change from a sum of the first amount of change and the fourth amount of change.

### [Configuration 7]

The display device according to configuration 5, in which the third amount of change is an amount of change obtained by subtracting an amount of change obtained by subtracting the fourth amount of change from the second amount of change from the first amount of change.

### [Configuration 8]

The display device according to any one of configurations 5 to 7, in which in a case where a user riding in a moving body uses the display device, the third amount of change is an amount of change of the controller relative to the moving body.

### [Configuration 9]

The display device according to any one of configurations 1 to 8, in which the display device is a device to be worn on a user's head.

### [Configuration 10]

The display device according to any one of configurations 5 to 7, in which the display control unit displays a background image on the display device based on the fourth amount of change.

### [Configuration 11]

An information processing device configured to receive an input via a controller, the information processing device including a display control unit configured to display a virtual object on a display device, a first obtaining unit configured to obtain a first amount of change as an amount of change in at least one of a position and an orientation of the controller, and a second obtaining unit configured to obtain a second amount of change as an amount of change in at least one of a position and an orientation of the display device, in which the display control unit displays the virtual object on the display device based on a third amount of change, the third amount of change being an amount of change in at least one of a position and an orientation based on the first amount of change and the second amount of change.

### [Configuration 12]

The information processing device according to configuration 11, in which the third amount of change is an amount of change of the controller relative to the display device.

### [Configuration 13]

The information processing device according to configuration 11 or 12, in which the third amount of change is an amount of change obtained by subtracting the second amount of change from the first amount of change.

### [Configuration 14]

The information processing device according to configuration 11, further including an image obtaining unit configured to obtain an image from the display device, an estimation unit configured to estimate at least one of the position and the orientation of the display device based on the image, and a fourth obtaining unit configured to obtain a fourth amount of change as an amount of change in at least one of the position and the orientation of the display device, based on a result of estimation by the estimation unit, in which the display control unit displays the virtual object on the display device based on the third amount of change, the third amount of change being an amount of change in at least one of a position and an orientation that is based on the first amount of change, the second amount of change, and the fourth amount of change.

### [Configuration 15]

The information processing device according to configuration 14, in which the third amount of change is an amount of change obtained by subtracting the second amount of change from a sum of the first amount of change and the fourth amount of change.

### [Configuration 16]

The information processing device according to configuration 14, in which the third amount of change is an amount of change obtained by subtracting an amount of change obtained by subtracting the fourth amount of change from the second amount of change from the first amount of change.

### [Configuration 17]

The information processing device according to any one of configurations 14 to 16, in which in a case where a user riding in a moving body uses the display device, the third amount of change is an amount of change of the controller relative to the moving body.

### [Configuration 18]

The information processing device according to any one of configurations 14 to 17, in which the display control unit displays a background image on the display device based on the fourth amount of change.

### [System]

A system for a display device configured to receive an input via a controller, the system including a display control device configured to display a virtual object on the display device, an obtaining device configured to obtain a first amount of change as an amount of change in at least one of a position and an orientation of the controller, and an inertial sensor configured to detect a second amount of change as an amount of change in at least one of a position and an orientation of the display device, in which the display control device displays the virtual object on the display device based on a third amount of change, the third amount of change being an amount of change in at least one of a position and an orientation based on the first amount of change and the second amount of change.

### [System]

A system for a display device configured to receive an input via a controller, the system including a display control device configured to display a virtual object on the display device, an obtaining device configured to obtain a first amount of change in at least one of a position and an orientation of the controller, an inertial sensor configured to detect a second amount of change as an amount of change in at least one of a position and an orientation of the display device, an image capturing device configured to obtain a captured image, an estimation device configured to estimate at least one of the position and the orientation of the display device based on the captured image, and a fourth obtaining device configured to obtain a fourth amount of change as an amount of change in at least one of the position and the orientation of the display device, based on a result of estimation by the estimation device, in which the display control device displays the virtual object on the display device based on the third amount of change that is based on the first amount of change, the second amount of change, and the fourth amount of change.

### [Program]

A program for causing a computer to function as each unit of the display device according to any one of configurations 1 to 10.

### [Control Method]

A control method for a display device configured to receive an input via a controller, the control method including displaying a virtual object on the display device, obtaining a first amount of change as an amount of change in at least one of a position and an orientation of the controller, detecting a second amount of change as an amount of change in at least one of a position and an orientation of the display device, obtaining a captured image, estimating at least one of the position and the orientation of the display device based on the captured image, and obtaining a fourth amount of change as an amount of change in at least one of the position and the orientation of the display device, based on a result of the estimating, in which in the displaying, the virtual object is displayed on the display device based on the third amount of change that is based on the first amount of change, the second amount of change, and the fourth amount of change.

### [Control Method]

A control method for a display device configured to receive an input via a controller, the control method including displaying a virtual object on the display device, obtaining a first amount of change as an amount of change in at least one of a position and an orientation of the controller, and detecting a second amount of change as an amount of change in at least one of a position and an orientation of the display device, in which in the displaying, the virtual object is displayed on the display device based on a third amount of change, the third amount of change being an amount of change in at least one of a position and an orientation based on the first amount of change and the second amount of change.

### [System]

A system for an information processing device configured to receive an input via a controller, the system including a display control device configured to display a virtual object on a display device, a first obtaining device configured to obtain a first amount of change as an amount of change in at least one of a position and an orientation of the controller, and a second obtaining device configured to obtain a second amount of change as an amount of change in at least one of a position and an orientation of the display device, in which the display control device displays the virtual object on the display device based on a third amount of change, the third amount of change being an amount of change in at least one of a position and an orientation based on the first amount of change and the second amount of change.

### [System]

A system for an information processing device configured to receive an input via a controller, the system including a display control device configured to display a virtual object on a display device, a first obtaining device configured to obtain a first amount of change as an amount of change in at least one of a position and an orientation of the controller, a second obtaining device configured to obtain a second amount of change as an amount of change in at least one of a position and an orientation of the display device, an image obtaining device configured to obtain an image from the display device, an estimation device configured to estimate at least one of the position and the orientation of the display device based on the image, and a fourth obtaining device configured to obtain a fourth amount of change as an amount of change in at least one of the position and the orientation of the display device, based on a result of estimation by the estimation device, in which the display control device displays the virtual object on the display device based on a third amount of change, the third amount of change being an amount of change in at least one a position and an orientation based on the first amount of change, the second amount of change, and the fourth amount of change.

### [Program]

A program for causing a computer to function as each unit of the information processing device according any one of configurations 11 to 18.

### [Control Method]

A control method for an information processing device configured to receive an input via a controller, the control method including controlling displaying a virtual object on a display device, obtaining a first amount of change as an amount of change in at least one of a position and an orientation of the controller, and obtaining a second amount of change as an amount of change in at least one of a position and an orientation of the display device, in which in the displaying, the virtual object is displayed on the display device based on a third amount of change, the third amount of change being an amount of change in at least one of a position and an orientation based on the first amount of change and the second amount of change.

### [Control Method]

A control method for an information processing device configured to receive an input via a controller, the control method including displaying a virtual object on a display device, obtaining a first amount of change as an amount of change in at least one of a position and an orientation of the controller, obtaining a second amount of change as an amount of change in at least one of a position and an orientation of the display device, obtaining an image from the display device, estimating at least one of the position and the orientation of the display device based on the image, and obtaining a fourth amount of change as an amount of change in at least one of the position and the orientation of the display device, based on a result of the estimating, in which in the displaying, the virtual object is displayed on the display device based on a third amount of change, the third amount of change being an amount of change in at least one a position and an orientation based on the first amount of change, the second amount of change, and the fourth amount of change.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-093384, filed Jun. 6, 2023, which is hereby incorporated by reference herein in its entirety.

What is claimed is:

1. An information processing device connected to or integrated into a display device configured to receive an input via a controller, the information processing device comprising:
a display control unit configured to control the display device to display a virtual object;
a first obtaining unit configured to obtain a first amount of change as an amount of change in one of a position and an orientation of the controller;
a second obtaining unit configured to obtain a second amount of change as an amount of change in one of a position and an orientation of the display device;
an image obtaining unit configured to obtain a captured image;
an estimation unit configured to estimate one of the position and the orientation of the display device based on the captured image; and
a third obtaining unit configured to obtain a third amount of change as an amount of change in one of the position and the orientation of the display device based on a result of the estimation by the estimation unit,
wherein the display control unit controls the display device to display the virtual object based on a fourth amount of change, the fourth amount of change being an amount of change in one of a position and an orientation based on the first amount of change, the second amount of change, and the third amount of change.

2. The information processing device according to claim 1, wherein the fourth amount of change is an amount of change obtained by subtracting the second amount of change from a sum of the first amount of change and the third amount of change.

3. The information processing device according to claim 1, wherein the fourth amount of change is an amount of change obtained by subtracting an amount of change obtained by subtracting the third amount of change from the second amount of change from the first amount of change.

4. The information processing device according to claim 1, wherein in a case where a user riding in a moving body uses the display device, the fourth amount of change is an amount of change of the controller relative to the moving body.

5. The information processing device according to claim 1, wherein the display device is a device to be worn on a user's head.

6. The information processing device according to claim 1, wherein the display control unit controls the display device to display a background image based on the third amount of change.

7. A control method for an information processing device connected to or integrated into a display device and to receive an input via a controller, the control method comprising:
controlling the display device to display a virtual object;
obtaining a first amount of change as an amount of change in one of a position and an orientation of the controller;
obtaining a second amount of change in one of a position and an orientation of the display device;
obtaining a captured image;
estimating one of the position and the orientation of the display device based on the captured image; and
obtaining a third amount of change as an amount of change in one of the position and the orientation of the display device based on a result of the estimation,
wherein in the display control, the virtual object is displayed on the display device based on a fourth amount of change, the fourth amount of change being an amount of change in one of a position and an orientation based on the first amount of change, the second amount of change, and the third amount of change.

8. A non-transitory computer readable storage medium storing a program for causing a computer to execute a control method for an information processing device connected to or integrated into a display device and to receive an input via a controller, the control method comprising:
controlling the display device to display a virtual object;
obtaining a first amount of change as an amount of change in one of a position and an orientation of the controller;
obtaining a second amount of change in one of a position and an orientation of the display device;
obtaining a captured image;
estimating one of the position and the orientation of the display device based on the captured image; and
obtaining a third amount of change as an amount of change in one of the position and the orientation of the display device based on a result of the estimation,
wherein in the display control, the virtual object is displayed on the display device based on a fourth amount of change, the fourth amount of change being an amount of change in one of a position and an orientation based on the first amount of change, the second amount of change, and the third amount of change.
